(19) United States
(12) Patent Application Publication
(10) Pub. No.: US 2007/0285016 A1
(43) Pub. Date: Dec. 13, 2007

(54) Bundle type fluorescent lamp adaptable for low temperature atmosphere

(76) Inventors: June-Gill Kang, Seoul (KR); Chang-Soo Choi, Yongin (KR); Dong-Han Yoon, Gumi (KR)

Correspondence Address: Thomas M. Galgano, Esq.;GALGANO & ASSOCIATES, PLLC, Suite 204, 20 West Park Avenue, Long Beach, NY, 11561, US

(21) Appl. No.: 11/451,798

(22) Filed: Jun. 13, 2006

(51) Int. Cl. H01J 61/30; H01J 17/16

(52) U.S. Cl. 313/634

(57) ABSTRACT

Disclosed is a bundle type fluorescent lamp adaptable for the lower temperature atmosphere, in which at least two fluorescent lamps are aligned in a row in the form of a bundle and are accommodated in a transparent or a semitransparent insulative cover, so that the bundle type fluorescent lamp represents superior operational characteristics even if it is installed in a freezing chamber or a cold storage warehouse. Each of the fluorescent lamps includes a glass tube filled with discharge gas and an electrode positioned at both side ends of the glass tube, wherein the fluorescent lamps are bound with each other in a form of a bundle and each electrode of the fluorescent lamps is electrically connected to a power source. The fluorescent lamp includes an external electrode fluorescent lamp, a cold cathode fluorescent lamp or a general fluorescent lamp. The fluorescent lamp is one selected from the group consisting of a straight type fluorescent lamp, a bending type fluorescent lamp and a spherical type fluorescent lamp. The fluorescent lamps are fixed in the form of the bundle by a clamp and accommodated in a single tube type or a multiple tube type transparent insulative cover.

### BACKGROUND OF THE INVENTION

1. Field of the Invention

The present invention relates to a bundle type fluorescent lamp adaptable for a low temperature atmosphere. More particularly, the present invention relates to a bundle type fluorescent lamp adaptable for a low temperature atmosphere, in which a plurality of fluorescent lamps are positioned in a transparent or a semitransparent insulative cover and aligned in a row in the form of a bundle, thereby allowing illumination units to have superior operational characteristics and light efficiency under the low temperature atmosphere, even if the illumination units are applied to freezing chambers and/or cooling chambers of refrigerators or display panels of bending machines, or even if the illumination units are used in high latitudes in the winter season.

2. Description of the Prior Art

Generally, a fluorescent lamp represents superior illumination performance with low power consumption and low installation cost, so the fluorescent lamp is extensively used as an illumination device. The fluorescent lamp is a sort of discharge lamps, in which a fluorescent material is coated on an inner wall of an elongated glass tube and Hg and Ar gases are provided in the elongated glass tube. When electric power is applied to electrodes installed at both sides of the elongated glass tube, a great amount of ultraviolet rays is discharged into the elongated glass tube. Such ultraviolet rays are absorbed in the fluorescent material so that the fluorescent material emits light, thereby attaining an illumination effect.

Hereinafter, a structure and an operational principle of a conventional fluorescent lamp will be described with reference to FIG. 1. FIG. 1 is a perspective view illustrating a conventional external electrode fluorescent lamp 1′.

Actually, a fluorescent lamp unit includes a straight-type, a bending-type or a spherical-type fluorescent lamp, a start lamp and a stabilizer, which are electrically connected to each other. Recently, a cold cathode fluorescent lamp (CCFL) or an external electrode florescent lamp (EEFL) has been developed and extensively used in order to minimize a size of the fluorescent lamp. However, FIG. 1 schematically shows the external electrode fluorescent lamp 1′ and a start lamp 30 for illustrative purpose only.

As shown in FIG. 1, the external electrode fluorescent lamp 1′ includes an elongated glass tube 20 having a substantially cylindrical shape as a light source, and the elongated glass tube 20 is provided at both sides thereof with electrode sections 10 in which filaments 11 are installed. Barium or strontium is coated on the filament 11 so as to allow thermal electrons to be easily discharged from the filament 11. As mentioned above, the elongated glass tube 20 is filled with Hg and Ar gases.

When a user turns on a power switch, supply voltage is instantly applied to the start lamp 30. The start lamp 30 includes a glass tube filled with argon gas, in which a fixing electrode 31 and a movable electrode 32 made from a bimetal are installed. As the supply voltage is applied to the start lamp 30, electric discharge may occur from an electrode gap of the start lamp 30, so the movable electrode 32 becomes longer due to heat applied to the movable electrode 32, so that the movable electrode 32 makes contact with the fixing electrode 31. At this time, a closed circuit is formed in the fluorescent lamp, so current is applied to the filaments 11 installed in the elongated glass tube 20 so that the filaments 11 are heated.

Then, thermal electrons are discharged from the filaments 11 and a great amount of ultraviolet rays are generated in the elongated glass tube 20 while evaporating Hg contained in the elongated glass tube 20. Such ultraviolet rays are absorbed in the fluorescent material so that the fluorescent material emits light, that is, the external electrode fluorescent lamp 1′ is lightened. When the electric discharge starts, tube current may gradually increase so that the electrode sections 10 may be broken. For this reason, a stabilizer (not shown) is separately connected to the external electrode fluorescent lamp 1′ in order to limit the tube current below a predetermined value. Reference numeral 12 is a coupling terminal pin, which is provided at both sides of the elongated glass tube 20 so as to connect the electrode sections 10 to a power source.

However, the conventional fluorescent lamp having the above structure represents an inferior efficiency under the low temperature atmosphere. In particular, if the temperature falls to 18 degrees below zero, the conventional fluorescent lamp is hardly lightened or is lightened with a low light efficiency below 10%. That is, as the ambient temperature falls down, tube current applied to the fluorescent lamp becomes reduced. Accordingly, when the ambient temperature falls to 18 degrees below zero, not only is the conventional fluorescent lamp hardly lightened, but also life span of the conventional fluorescent lamp is shortened.

Therefore, although the conventional fluorescent lamp represents superior illumination performance with low power consumption and low installation cost, if the conventional fluorescent lamp is provided in high latitudes above 30 degrees of the north latitude, or installed in freezing chambers or cooling chambers of refrigerators, or display panels of bending machines in the winter season, the fluorescent lamp is hardly lightened at an early stage of lightening or is lightened with a low light efficiency. In addition, life span of the fluorescent lamp may be shortened.

### SUMMARY OF THE INVENTION

Accordingly, the present invention has been made to solve the above-mentioned problems occurring in the prior art, and an object of the present invention is to provide a fluorescent lamp capable of representing a superior light efficiency at an early stage of lightening under the low temperature atmosphere of about 18 degrees below zero.

Another object of the present invention is to provide a fluorescent lamp capable of representing stable and superior brightness characteristics at an early stage of lighting under the low temperature atmosphere below zero, thereby attaining a high-energy efficiency.

Still another object of the present invention is to provide a fluorescent lamp, which is adaptable for a low temperature atmosphere without shortening life span thereof.

Still another object of the present invention is to provide a bundle type fluorescent lamp adaptable for a low temperature atmosphere, in which a plurality of fluorescent lamps are positioned in a transparent insulative cover and aligned in a row in the form of a bundle, thereby allowing illumination units to have superior operational characteristics and light efficiency under the low temperature atmosphere, even if the illumination units are applied to freezing chambers or cooling chambers of refrigerators or the like.

In order to accomplish the above objects, according to the present invention, there is provided a bundle type fluorescent lamp adaptable for a low temperature atmosphere, the bundle type fluorescent lamp comprising: a plurality of fluorescent lamps, each of which includes a glass tube filled with discharge gas and an electrode positioned at both side ends of the glass tube, wherein the fluorescent lamps are bound with each other in a form of a bundle and each electrode of the fluorescent lamps is electrically connected to a power source.

According to the preferred embodiment of the present invention, the electrode is an internal electrode installed in the glass tube, and each internal electrode is electrically connected to a stabilizer and a start lamp provided at an external portion of the internal electrode or each internal electrode is electrically connected to an electronic stabilizer provided at an external portion of the internal electrode.

The electrode is an external electrode installed at both side ends of the glass tube while surrounding both side ends of the glass tube, and each extern electrode is electrically connected to a single power source through an inverter.

The fluorescent lamps are fixed in the form of the bundle by means of a clamp and the fluorescent lamps in the form of the bundle are accommodated in at least one tube type transparent or semitransparent insulative cover.

The fluorescent lamp is one selected from the group consisting of a straight type fluorescent lamp, a bending type fluorescent lamp and a spherical type fluorescent lamp. A cold cathode fluorescent lamp can be used instead of the external electrode fluorescent lamp.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view illustrating a structure of a conventional external electrode fluorescent lamp;

FIG. 2 is a perspective view illustrating a bundle type fluorescent lamp including a plurality of internal electrode fluorescent lamps aligned in the form of a bundle according to one embodiment of the present invention;

FIG. 3 is a circuit view illustrating an electric connection between fluorescent lamps of a bundle type fluorescent lamp shown in FIG. 2 according to one embodiment of the present invention;

FIG. 4 is a circuit view illustrating an electric connection between fluorescent lamps of a bundle type fluorescent lamp shown in FIG. 2 according to another embodiment of the present invention;

FIGS. 5a to 5c are perspective views illustrating a bundle type fluorescent lamp including a plurality of external electrode fluorescent lamps adaptable for a low temperature atmosphere according to another embodiment of the present invention,

FIG. 6 is a circuit view illustrating an electric connection between external electrode fluorescent lamps shown in FIG. 5a according to one embodiment of the present invention;

FIG. 7 is a perspective view illustrating a bundle type fluorescent lamp accommodated in a transparent insulative cover or a semitransparent insulative cover, and

FIG. 8 is a perspective view illustrating a bundle type fluorescent lamp shown in FIG. 7 connected to a power source through a multiple clamp and a single electrode.

### DETAILED DESCRIPTION OF THE PREFERRED EMBODIMENTS

Hereinafter, the present invention will be described with reference to accompanying drawings.

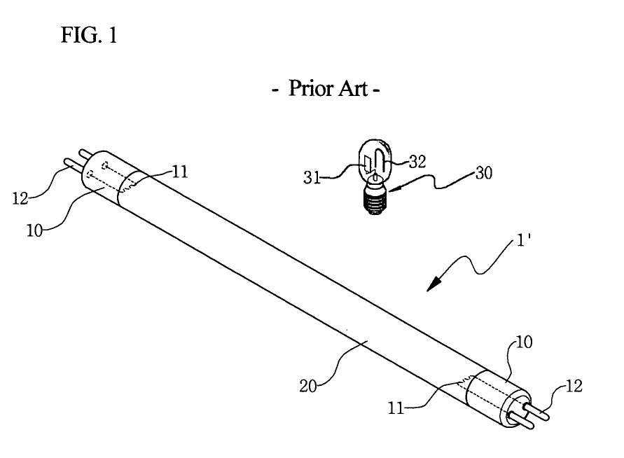

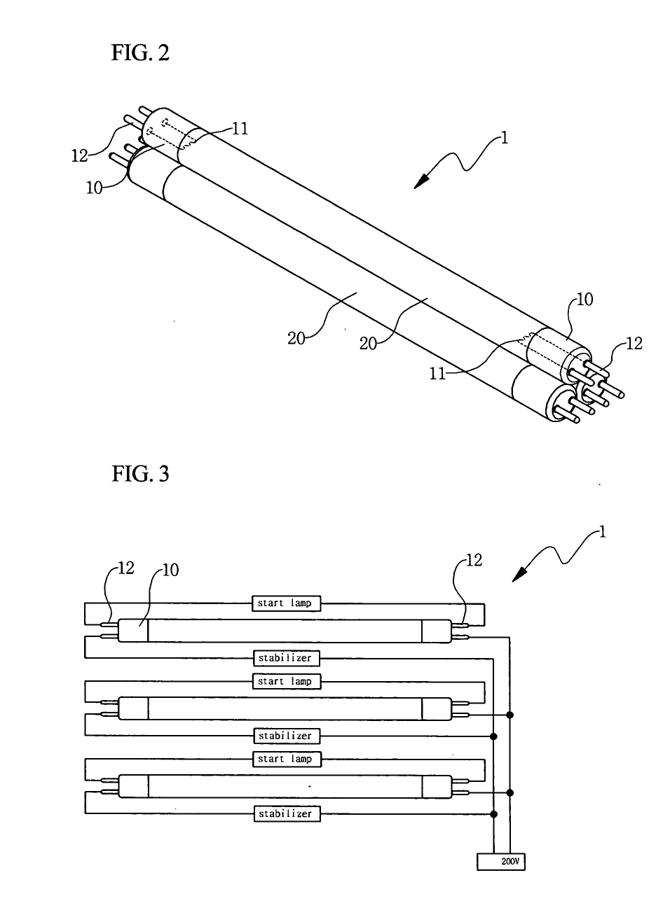

FIG. 2 is a perspective view illustrating a bundle type fluorescent lamp including a plurality of internal electrode fluorescent lamps aligned in the form of a bundle according to one embodiment of the present invention, and FIG. 3 is a circuit view illustrating an electric connection between the internal fluorescent lamps of the bundle type fluorescent lamp shown in FIG. 2. In the following description, FIGS. 2 and 3 will be explained together for the purpose of convenience. In addition, the bundle type fluorescent lamp 1 shown in FIGS. 2 and 3 has at least two conventional glass type fluorescent lamps 1′ aligned in a row. Therefore, the following description will be focused on the differences between the bundle type fluorescent lamp 1 and the conventional glass type fluorescent lamp 1′ shown in FIG. 1.

As shown in FIG. 2, the bundle type fluorescent lamp 1 according to the present invention includes three fluorescent lamps, which are bundled in a row. Each of three fluorescent lamps includes a glass tube 20, which is filled with Hg and Ar gases and a fluorescent layer (not shown) is coated on an inner peripheral wall thereof, and an electrode 10 positioned at both sides of the glass tube 20. Although the bundle type fluorescent lamp 1 including three fluorescent lamps is illustrated in FIGS. 2 and 3, the bundle type fluorescent lamp 1 may have two or four fluorescent lamps. The present invention does not limit the number of fluorescent lamps. In addition, a fixing unit, such as a clamp or an adhesive, can be used to bind the fluorescent lamps with each other. However, the present invention does not limit the sort of fixing units. In addition, although straight type fluorescent lamps are shown in FIGS. 2 and 3, the present invention can employ bending type or spherical type fluorescent lamps without limitation.

As shown in FIG. 3, in order to electrically connect the fluorescent lamps of the bundle type fluorescent lamp 1 with each other, a stabilize and a start lamp are provided at external portions of the fluorescent lamps, respectively. That is, according to the present invention, a plurality of fluorescent lamps of the bundle type fluorescent lamp 1 are electrically bound with each other in a row, so that the bundle type fluorescent lamp 1 can be effectively operated under the low temperature atmosphere as compared with the single type fluorescent lamp.

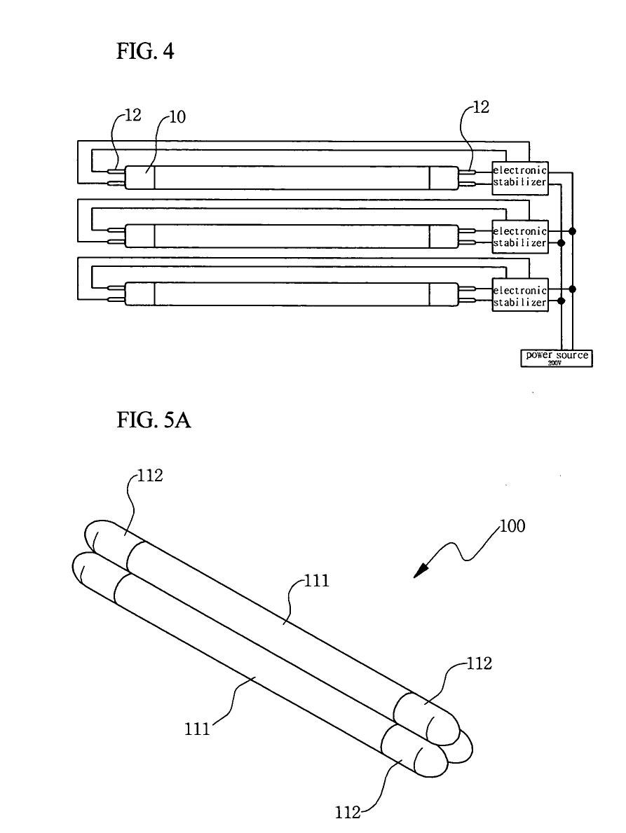

FIG. 4 is a circuit view illustrating an electric connection between fluorescent lamps of the bundle type fluorescent lamp shown in FIG. 2 according to another embodiment of the present invention. According to the present embodiment, an electronic stabilizer is employed instead of the mechanical stabilize shown in FIG. 3. Accordingly, the start lamp is not necessary in order to turn on the bundle type fluorescent lamp, so loss of start power caused by flickering of the start lamp may not occur.

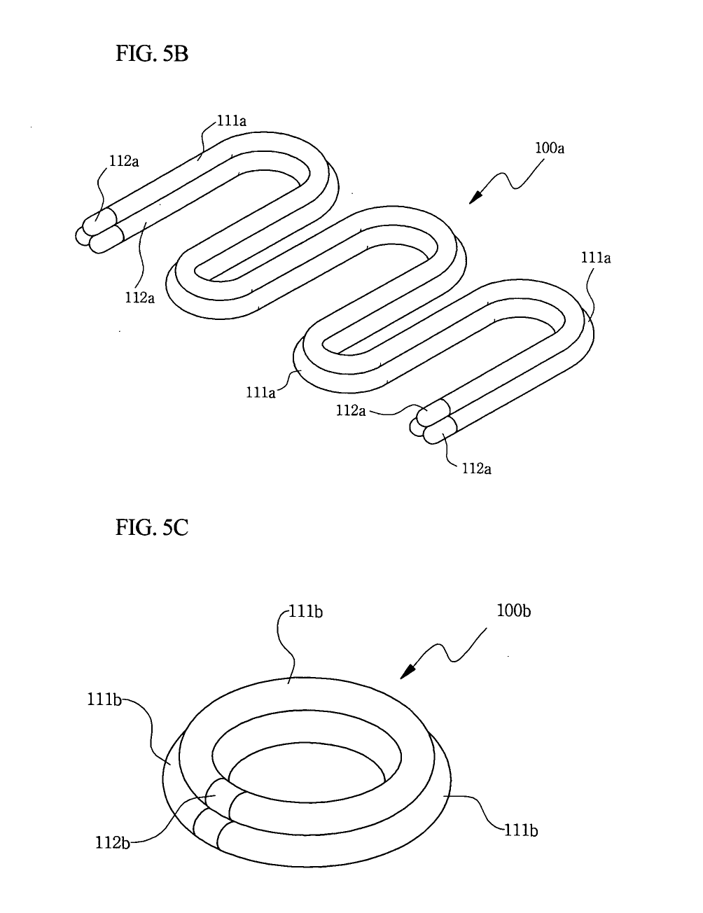

FIGS. 5a to 5c are perspective views illustrating bundle type fluorescent lamps 100, 100a and 100b including a plurality of fluorescent lamps adaptable for a low temperature atmosphere according to another embodiment of the present invention. According to the present embodiment, the bundle type fluorescent lamps includes a plurality of external electrode fluorescent lamps having external electrodes 112, 112a and 112b, instead of internal fluorescent lamps 1 having electrode sections 12 shown in FIGS. 2 to 4. Thus, the following description will be focused on the differences between the bundle type fluorescent lamps 100, 100a and 100b shown in FIGS. 5a to 5c and the bundle type fluorescent lamp 1 shown in FIGS. 2 to 4.

The external electrode fluorescent lamps 100, 100a and 100b include cylindrical glass tubes 111, 111a and 111b having a diameter of about a few millimeters. External electrodes 112, 112a and 112b are installed at both ends of the cylindrical glass tubes 111, 111a and 111b while surrounding both ends of the cylindrical glass tubes. A fluorescent material is coated on an inner peripheral wall of the cylindrical glass tubes. Both ends of the cylindrical glass tubes are sealed after discharge gas including inert gas and Hg gas has been filled in the cylindrical glass tubes. The external electrode fluorescent lamp has life span longer than that of the general fluorescent lamp with a higher efficiency. In addition, since the external electrode fluorescent lamp has a parallel drive mechanism, a plurality of external electrode fluorescent lamps can be simultaneously driven by means of a single stabilizer. The external electrodes 112, 112a and 112b are made from a conductive material having a low electric resistance characteristic, such as Al, Ag or Cu. In addition, the external electrode can be formed in various shapes, such as an L-shape, a spiral-shape, and a wave-shape.

As shown in FIG. 5a, the bundle type fluorescent lamp 100 includes three external electrode fluorescent lamps having external electrodes 112 surrounding both ends of the glass tubes 111. However, the bundle type fluorescent lamp 100 may have two or four external electrode fluorescent lamps. However, the present invention does not limit the number of external electrode fluorescent lamps. In addition, a fixing unit, such as a clamp or an adhesive, can be used to bind the external electrode fluorescent lamps with each other. In addition, although the bundle type fluorescent lamp 100 including straight type external electrode fluorescent lamps is shown in FIG. 5a, according to another embodiment of the present invention, a bundle type fluorescent lamp 100a having bending type external electrode fluorescent lamps as shown in FIG. 5b or a bundle type fluorescent lamp 100b having spherical type external electrode fluorescent lamps as shown in FIG. 5c can be employed. The present invention does not limit the shapes of the bundle type fluorescent lamp.

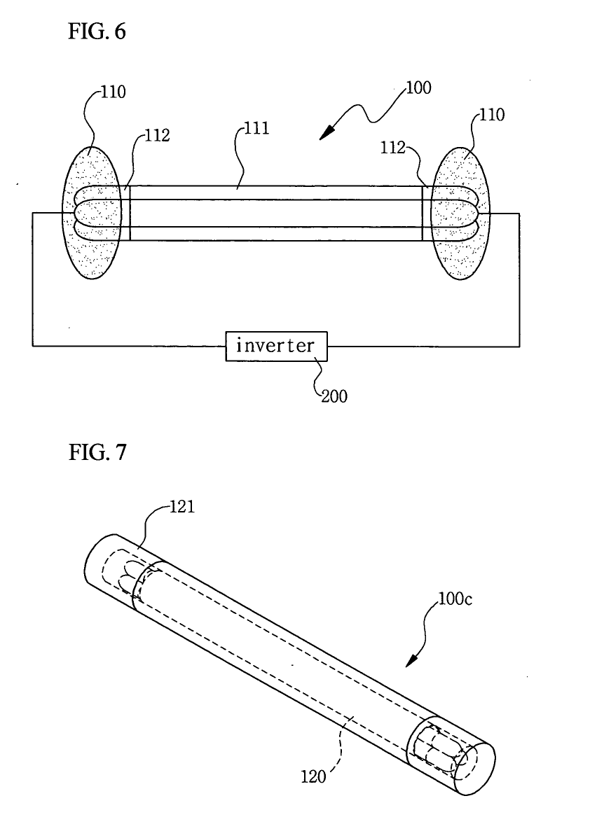

FIG. 6 is a circuit view illustrating an electric connection between external electrode fluorescent lamps shown in FIG. 5a according to one embodiment of the present invention.

As shown in FIG. 6, the bundle type fluorescent lamp 100 including three external electrode fluorescent lamps is connected to a single power source through an inverter 200. Since the bundle type fluorescent lamp 100 including three external electrode fluorescent lamps is connected to the single power source, the bundle type fluorescent lamp 100 can be effectively operated under the lower temperature atmosphere of about 18 degrees below zero, while minimizing and simplifying an external wiring structure thereof. Thus, manufacturing and installation works for the bundle type fluorescent lamp 100 become simplified.

In the meantime, the inverter 2, which is a power supply unit for driving the bundle type fluorescent lamp 100, is mainly classified into a switching type inverter and an LC-resonance type inverter. A square wave is applied to the bundle type fluorescent lamp 100 through the switching type inverter when it is necessary to achieve high brightness, and a sine wave is applied to the bundle type fluorescent lamp 100 through the LC-resonance type inverter when it is necessary to drive the single fluorescent lamp or plural fluorescent lamps at low power consumption. However, the present invention does not limit the sort of the inverters.

In addition, the switching type inverters can be classified into full-bridge type inverters, half-bridge type inverters, push-pull type inverters, and multiple vibration type inverters. Since the sort of the inverters is generally known in the art, it will not be further described below.

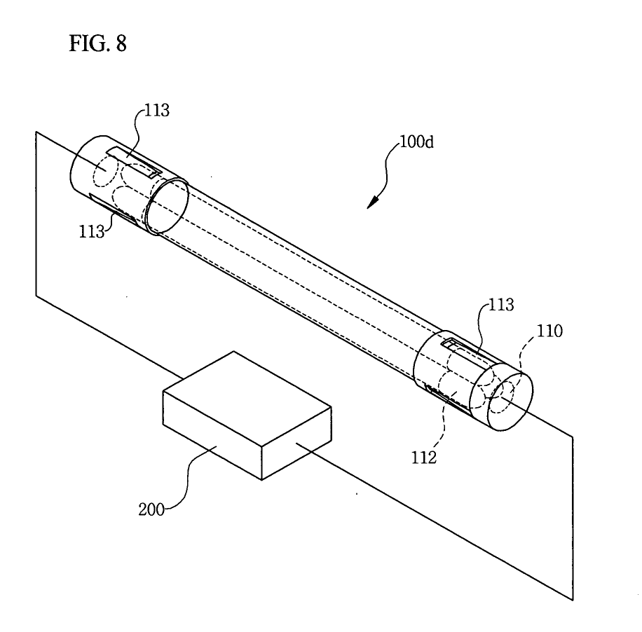

FIG. 7 is a perspective view illustrating a bundle type fluorescent lamp 100c accommodated in a transparent insulative cover, and FIG. 8 is a perspective view illustrating the bundle type fluorescent lamp shown in FIG. 7 connected to the power source through a multiple clamp and a single electrode.

As shown in FIG. 7, the bundle type fluorescent lamp 100c is accommodated in at least one or two transparent insulative covers 120 and 121 in the form of a multiple tube. Although the insulative cover is preferably made from a transparent material, the insulative cover can be made from a semitransparent material. In addition, the transparent material or the semi ant material includes glass, resin, plastic or polyester. However, the present invention does not limit the material for the transparent or semitransparent insulative covers, if it has an insulative characteristic. After bundling at least two external electrode fluorescent lamps, preferably, at least three external electrode fluorescent lamps, the bundle type fluorescent lamp is accommodated in the transparent insulative covers 120 and 121, so the bundle type fluorescent lamp may operate with superior operational characteristics under the low temperature below zero.

As shown in FIG. 8, the bundle type fluorescent lamp 100d is fixedly accommodated in two transparent insulative covers 120 and 121 by means of a clamp 113. In addition, the external electrodes 112 are connected to an inverter 200 through a single electrode 110, so that the bundle type fluorescent lamp 100d may represent superior brightness and energy efficiency under the low temperature below zero.

Meanwhile, although the external electrode fluorescent lamps are preferably bundled by means of the clamp 113, they can be bonded to each other by means of an adhesive. As mentioned above, the present invention does not limit the fixing unit used for binding the external electrode fluorescent lamps to each other. In addition, although the present invention has been described in relation to the external electrode fluorescent lamps (EEFLs), the bundle type fluorescent lamp of the present invention can employ cold cathode fluorescent lamps (CCFLs) having a slim size. In this case, the bundle type fluorescent lamp may represent high brightness and superior color rendition at low power consumption.

The following graph shows the brightness difference between the general fluorescent lamp and the external electrode fluorescent lamp of the present invention. However, it should be noted that this graph is for illustrative purpose only and does not intend to limit the scope of the present invention.

Temperature Test Result (Under the Temperature of −22° C.)

The above graph shows brightness of three kinds of fluorescent lamps (a conventional fluorescent lamp, a fluorescent lamp having a single lamp and a single insulative cover, and a fluorescent lamp having three lamps and two insulative covers) as a function of time under the temperature of −22° C.

As can be understood from the above graph, initial brightness of the fluorescent lamp having three lamps and two insulative covers according to the present invention increases with a steep angle as compared with that of the conventional fluorescent lamp. As time goes by, brightness of the fluorescent lamp is stabilized at 4500 cd/m². Thus, the fluorescent lamp of the present invention may represent brightness efficiency higher than that of the conventional fluorescent lamp by four times.

As described above, according to the bundle type fluorescent lamp of the present invention adaptable for the lower temperature atmosphere, at least two fluorescent lamps are aligned in a row in the form of a bundle and are accommodated in at least two transparent insulative covers. Accordingly, the bundle type fluorescent lamp of the present invention can represent superior brightness and energy efficiency even if it is installed in a freezing chamber or a cold storage warehouse.

Although a preferred embodiment of the present invention has been described for illustrative purposes, those skilled in the art will appreciate that various modifications, additions and substitutions are possible, without departing from the scope and spirit of the invention as disclosed in the accompanying claims.

1. A bundle type fluorescent lamp adaptable for a low temperature atmosphere, the bundle type fluorescent lamp comprising:
a plurality of fluorescent lamps, each of which includes a glass tube filled with discharge gas and an electrode positioned at both side ends of the glass tube, wherein the fluorescent lamps are bound with each other in a form of a bundle and each electrode of the fluorescent lamps is electrically connected to a power source.

2. The bundle type fluorescent lamp as claimed in claim 1, wherein the electrode is an internal electrode installed in the glass tube, and each internal electrode is electrically connected to a stabilizer and a start lamp provided at an external portion of the internal electrode.

3. The bundle type fluorescent lamp as claimed in claim 1, wherein the electrode is an internal electrode installed in the glass tube, and each internal electrode is electrically connected to an electronic stabilizer provided at an external portion of the internal electrode.

4. The bundle type fluorescent lamp as claimed in claim 1, wherein the electrode is an external electrode installed at both side ends of the glass tube while surrounding both side ends of the glass tube, and each external electrode is electrically connected to a single power source through an inverter.

5. The bundle type fluorescent lamp as claimed in claim 1, wherein the fluorescent lamps are fixed in the form of the bundle by means of a clamp.

6. The bundle type fluorescent lamp as claimed in claim 1, wherein the fluorescent lamps in the form of the bundle are accommodated in at least one tube type transparent or semitransparent insulative cover.

7. The bundle type fluorescent lamp as claimed in claim 1, wherein the fluorescent lamp is one selected from the group consisting of a straight type fluorescent lamp, a bending type fluorescent lamp and a spherical type fluorescent lamp.

8. The bundle type fluorescent lamp as claimed in claim 1, wherein the fluorescent lamp includes a cold cathode fluorescent lamp.

9. The bundle type fluorescent lamp as claimed in claim 2, wherein the fluorescent lamps are fixed in the form of the bundle by means of a clamp.

10. The bundle type fluorescent lamp as claimed in claim 3, wherein the fluorescent lamps are fixed in the form of the bundle by means of a clamp.

11. The bundle type fluorescent lamp as claimed in claim 4, wherein the fluorescent lamps are fixed in the form of the bundle by means of a clamp.

12. The bundle type fluorescent lamp as claimed in claim 2, wherein the fluorescent lamps in the form of the bundle are accommodated in at least one tube type transparent or semitransparent insulative cover.

13. The bundle type fluorescent lamp as claimed in claim 3, wherein the fluorescent lamps in the form of the bundle are accommodated in at least one tube type transparent or semitransparent insulative cover.

14. The bundle type fluorescent lamp as claimed in claim 4, wherein the fluorescent lamps in the form of the bundle are accommodated in at least one tube type transparent or semitransparent insulative cover.

15. The bundle type fluorescent lamp as claimed in claim 2, wherein the fluorescent lamp is one selected from the group consisting of a straight type fluorescent lamp, a bending type fluorescent lamp and a spherical type fluorescent lamp.

16. The bundle type fluorescent lamp as claimed in claim 3, wherein the fluorescent lamp is one selected from the group consisting of a straight type fluorescent lamp, a bending type fluorescent lamp and a spherical type fluorescent lamp.

17. The bundle type fluorescent lamp as claimed in claim 4, wherein the fluorescent lamp is one selected from the group consisting of a straight type fluorescent lamp, a bending type fluorescent lamp and a spherical type fluorescent lamp.
